(19) United States
(12) Patent Application Publication
(10) Pub. No.: US 2012/0146917 A1
(43) Pub. Date: Jun. 14, 2012

(54) KEY INPUT APPARATUS CAPABLE OF DISPLAYING KEY INPUT USING LIGHT AND METHOD OF EMITTING THE LIGHT

(75) Inventors: Sung-Ryong Hong, Goyang-si (KR); Ju-Tae Kim, Seongnam-si (KR)

(73) Assignee: TimeSpaceSystem Co., Ltd., Seoul (KR)

(21) Appl. No.: 13/304,627

(22) Filed: Nov. 26, 2011

(30) Foreign Application Priority Data
Dec. 10, 2010 (KR) 10-2010-0126478

(51) Int. Cl. G06F 3/02

(52) U.S. Cl. 345/170

(57) ABSTRACT

A key input apparatus capable of displaying a key input using light and a method of emitting the light are provided. The key input apparatus includes: a display unit; a key input unit configured to output a key signal in response to pressing a particular key corresponding to the character or number among a plurality of the keys, and distinguish the particular key from the other keys using light; and a control unit configured to output information on the character or number to the display unit in response to the key signal, and control a period of time for which the particular key is distinguishable using light to be longer than a period of time for which the particular key has been pressed.

### CROSS-REFERENCE TO RELATED APPLICATION(S)

This application claims the benefit under 35 U.S.C. §119(a) of Korean Patent Application No. 10-2010-0126478, filed on Dec. 10, 2010, in the Korean Intellectual Property Office, the entire disclosure of which is incorporated herein by reference for all purposes.

### BACKGROUND

1. Field

The following description relates to a key input apparatus capable of displaying a key input using light and method of emitting the light, and more particularly, to a key input apparatus capable of displaying a key input using light that contributes to shortening of key input time, and is a method of emitting the light.

2. Description of the Related Art

The use of mobile devices such as mobile phones and smart phones has been increasing. The mobile devices are limited in size to enhance portability, and thus use a compact keypad, a small touch panel, and the like. A touch panel displays an image of, for example, a keypad or a keyboard on a screen, and allows a user to input a character or a number with the user's finger, a stylus pen, or the like. The touch panel matches a point which the user's finger or the stylus pen touches to a position of a key on the displayed image of the keypad or keyboard, thereby receiving the user's input. In addition, when a key on the keypad or keyboard of the touch panel is pressed, the touch panel may deliver sound or vibration to make the user to recognize the key being pressed.

In such existing mobile devices, the keypad or the touch panel is so small that the user may easily fail to input a correct key and may not recognize a wrongly pressed key. To solve such drawbacks, the existing mobile devices may generate sound or vibration upon a key being pressed, or enlarge a character or a number corresponding to a pressed key. That is, in response to a key being pressed, a mobile device generates sound or vibration or enlarges an input character on a screen, thereby allowing a user to recognize the key being pressed. However, because such sound, vibration or enlarged character disappears when the pressed key returns to an original state, it cannot be a fundamental solution to a wrong key input.

In particular, although the existing mobile device equipped with a touch panel produces sound or vibration, or enlarges an input character upon a key being pressed, actually the character corresponding to the key is input when the pressed key returns to an original state. That is, a pressed key does not necessarily mean that the key is input. This phenomenon is is another primary reason of a wrong key input.

### SUMMARY

The following description relates to a key input apparatus capable of displaying a key input using light and a method of emitting the light, which allow a user to visibly recognize a key input in a key input unit by the light and thereby quickly recognize a wrong key input so that key input time can be reduced.

In one general aspect, there is provided a key input apparatus capable of displaying a key input using light, including: a display unit configured to display an input character and/or an input number; a key input unit configured to include a plurality of keys, output a key signal in response to pressing a particular key corresponding to the character or number among a plurality of the keys, and distinguish the particular key from the other keys using light; and a control unit configured to output information on the character or number to the display unit in response to the key signal, display the character or number corresponding to the particular key in the display unit and control a period of time for which the particular key is distinguishable using light to be longer than a period of time for which the particular key has been pressed.

The control unit may be further configured to distinguish the particular key from the other keys by a difference in brightness of emitted light therefrom, to set the difference in brightness to change over time, and, if there are a plurality of particular keys, to allow a user to recognize an input order of the particular keys based on brightness of emitted light from the particular keys.

The control unit may be further configured to control a particular key to emit light, among a plurality of the keys, so as to be distinguished from the other keys.

The control unit may be further configured to control all keys other than a particular key among a plurality of the keys to emit light so as for the particular key to be distinguished from the other keys.

The control unit may be further configured to control a plurality of pressed keys to sequentially emit light of different colors according to an order of pressing the keys.

The control unit may be further configured to set the colors of light corresponding to an order of pressing a plurality of the keys.

The control unit may be further configured to control the particular key to emit light in a particular shape.

The control unit may be further configured to set an order of shapes of light in accordance with an order of pressing a plurality of the keys.

In another general aspect, there is provided a method of emitting light from a key input apparatus, including: recognizing a particular key being pressed in a key input unit including a plurality of keys; and emitting light from the pressed particular key for a predetermined period of time which is longer than a period of time for which the particular key has been pressed.

In the emitting of the light, the key input unit may distinguish the particular key from the other keys by a difference in brightness of emitted light therefrom, and set the difference in brightness to change over time, and, if there are a plurality of particular keys in the key input unit, the key input unit may display key inputs using light such that a user can recognize an input order of the particular keys based on brightness of emitted light from the particular keys.

The emitting of the light may include emitting light of different colors according to an order of pressing the particular keys.

The emitting of the light may include emitting light in different shapes according to an order of pressing the particular keys.

Other features and aspects may be apparent from the following detailed description, the drawings, and the claims.

### BRIEF DESCRIPTION OF THE DRAWINGS

FIG. 1 is a block diagram illustrating a key input apparatus according to an exemplary embodiment of the present invention.

FIG. 2 is a diagram illustrating an example of a display of a key input unit illustrated in FIG. 1.

FIG. 3 is a diagram illustrating another example of a display of a key input unit illustrated in FIG. 1.

FIG. 4 is a diagram illustrating a perspective view of an example of a mobile device equipped with a key input apparatus according to an exemplary embodiment of the present invention.

FIG. 5 is a diagram illustrating a perspective view of another example of a mobile device equipped with a key input apparatus according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

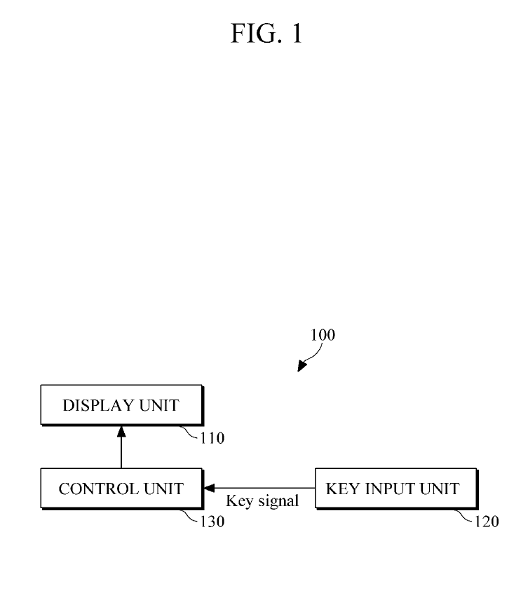

FIG. 1 is a block diagram illustrating a key input apparatus according to an exemplary embodiment of the present invention. Referring to FIG. 1, key input apparatus 100 may include a display unit 110, a key input unit 120, and a control unit 130.

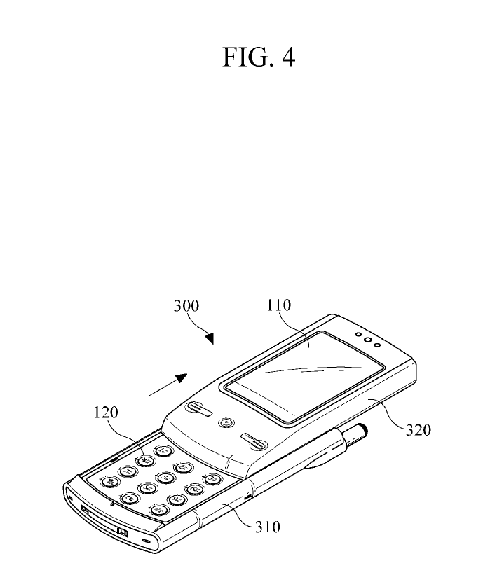

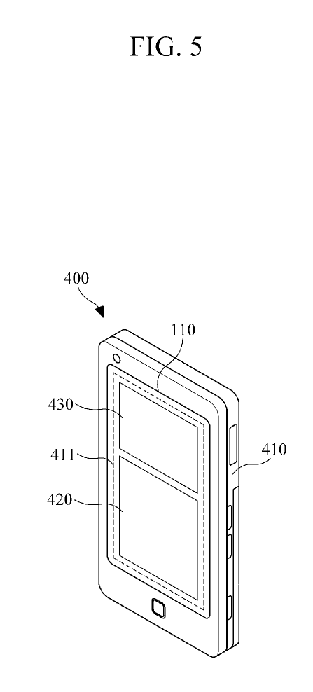

The display unit 110 may be equipped in a mobile device as a display to show information provided by the mobile device and display a key input through the key input unit 120, allowing a user to determine whether a correct key is input. The display unit 110 equipped in a mobile device as shown in FIG. 4 may display information about the mobile device and characters and/or numbers input through the key input unit 120. In addition, the display unit 110 equipped in a mobile device as shown in FIG. 5 may include a touch panel on a front surface, display an image for receiving inputs, for example, a keyboard or a keypad on a first region, and display characters and/or numbers on a second region corresponding to the information of the mobile device and/or a signal input through the key input unit 120. Moreover, the display unit 110 may emit light corresponding to a particular key that is determined as being touched, thereby allowing the user to visibly recognize the input of the key. The display unit 110 may control the particular key to emit light or control the other keys to emit light. When keys other than a particular key are controlled to emit light, at an initial stage, the particular key may not emit light or may emit light of low brightness, and then emit light of gradually increasing brightness over time.

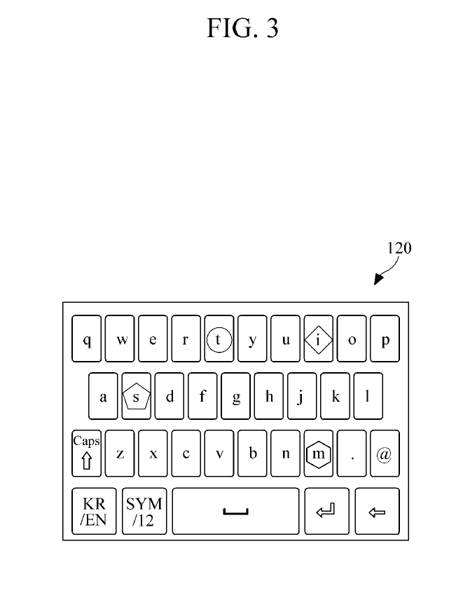

The key input unit 120 may include a plurality of keys, and generate a key signal containing key information about a character or a number in response to pressing on the key. The key input unit 120 as implemented in the mobile device as shown in FIG. 3 may enable the is user to visibly recognize a particular key by emitting light corresponding to the particular key in response to pressing on the key. In addition, the key input unit 120 as used in the mobile device as shown in FIG. 4 may be implemented as a touch panel. A position touched on the touch panel is mapped to a position of each of a plurality of keys on a keyboard or a keypad displayed as an image on the display unit 110, thereby allowing the user to identify the touched key and generating a key signal containing information on the touched key.

The control unit 130 may receive a key signal that corresponds to a particular key pressed through the key input unit 120, identify information on a character or a number included in the key signal, and control the identified character or number to be displayed on the display unit 110. In the case of the key input unit 120 implemented as a touch panel, the control unit 130 may control the display unit 110 to display a keyboard or a keypad. In addition, a position of a touched key among a plurality of keys on the keyboard or the keypad which corresponds to a touched point on the key input unit 120 is recognized and a touched key is identified based on the recognized position. Then, a key signal corresponding to the touched key is generated and transmitted to the control unit 130, and in response, the control unit 130 controls the display unit 110 to display a character or a number corresponding to the key signal.

The control unit 130 as applied to the mobile device as shown in FIG. 4 may control a lighting unit (not illustrated) included in the key input unit 120 to emit light from a particular key on which touch is sensed among a plurality of keys. In this case, the control unit 130 may control a period of time for which light is emitted to be longer than a period of time for which the key has been pressed, such that the light is emitted for a predetermined period of time after pressing the key and thus the user can visibly recognize the pressed key. The control unit 130 may control light to be emitted only from the pressed key, thereby distinguishing the pressed key from the other non-pressed keys, or may control light to be emitted only from non-pressed keys, is thereby distinguishing the non-pressed keys from a particular pressed key.

In a case where a particular key emits light, the control unit 130 may control the particular key to emit light which gradually decreases in brightness over time. Alternatively, in a case where all keys other than a particular key emit light, the control unit 130 may control the particular key to initially emit no light and gradually emit light which increases in brightness over time (that is, such that a difference of brightness between the particular key and the other keys can be reduced over time), thereby allowing the user to distinguish the particular key from the other keys. Moreover, the control unit 130 may set different colors for keys according to the input order of keys.

Furthermore, the control unit 130 as applied to the mobile device as shown in FIG. 3 may control the display unit 110 such that an image of a particular key that is detected as being pressed can be distinguished using light, among a plurality of keys. The control unit 130 may control the display unit 110 to have a longer period of time for emitting light than a period of time for pressing a key, such that the light can be emitted for a predetermined period of time after pressing the key, thereby allowing the user to visibly recognize the pressing of the key. In this case, the control unit 130 may control either the particular pressed key or all keys other than the particular pressed key to emit light only, thereby distinguishing the pressed key from the other keys.

In particular, in the case in which a particular key emits light, the control unit 130 may control the particular key to emit light which gradually decrease in brightness. Alternatively, in the case in which all keys other than a particular key emit light, the control unit 130 may control the particular key to initially emit no light and gradually increase the brightness of light (that is, such that a difference of brightness between the light from the particular key and the light from is the other keys can be reduced over time), thereby distinguishing the particular key from the other keys. Further, the control unit 130 may set different colors for keys according to the input order of the keys.

After confirming that a key input has been performed, the control unit 130 may control light to be emitted from a corresponding pressed key when the pressed key returns to its normal state.

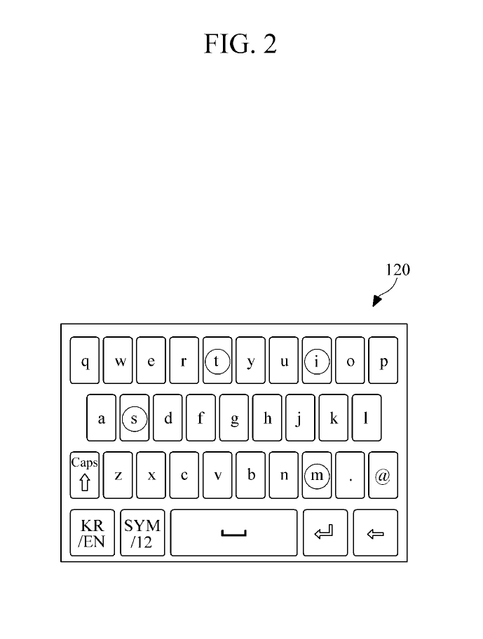

FIG. 2 is a diagram illustrating an example of a display of a key input unit illustrated in FIG. 1.

Key input unit 120 may include a plurality of keys, each having a character or a symbol displayed thereon, and a circle ‘∘’ on a character represents that the character is emitting light.

Referring to FIG. 2, it is noted that characters, ‘t’, ‘i’, ‘m’, and ‘s’, with ‘∘’ thereon are emitting light. In this case, the brightness of the light emitted from the characters sequentially decreases with the input order of the characters, and thus a user can identify the input order of the characters based on the changes in brightness. In addition, the key input unit 120 may be set to emit light of red, yellow, blue and green color in this order according to the order of pressing the key. Thus, when the character keys, ‘t’, ‘i’, ‘m’, and ‘s’, emit light of red, yellow, blue and green color, it can be recognized from the radiating keys that ‘t’, ‘i’, ‘m’, and ‘s’ keys are sequentially input, without the user having to see the display unit 110.

Hence, the user is allowed to easily identify the input keys and the input order of the keys using the key input unit 120 and correct wrong key input, and thus the key input time can be reduced.

FIG. 3 is a diagram illustrating another example of a display of a key input unit illustrated in FIG. 1.

Referring to FIG. 3, key input unit 120 may include a plurality of keys, each having a character or a symbol displayed thereon, and it is represented that characters with figures of different forms are emitting light. That is, the characters, ‘t’, ‘i’, ‘m’, and ‘s’, are emitting light in shapes of a circle, a diamond, a pentagon, and a hexagon, respectively. The light emitted in different shape from each key may decrease in brightness over time, thereby allowing the user to recognize the input order of keys.

The above examples illustrated in FIGS. 2 and 3 describe the shapes and colors of light, but the examples are not limited thereto. It should be appreciated that any other means to visibly distinguish a particular key from the other keys may be applied. For example, a key may be enlarged in response to being pressed and gradually decrease in size, or a character inside the pressed key may be enlarged.

FIG. 4 is a diagram illustrating a perspective view of an example of a mobile device equipped with a key input apparatus according to an exemplary embodiment of the present invention.

Referring to FIG. 4, mobile device 300 may include a first body 310 equipped with a key input unit 120 and a second body 210 equipped with a display unit 110. The mobile device 300 may include the key input unit 120 formed on an upper portion of the first body 310 and a control unit inside the first body 310. The display unit 110 is formed on an upper portion of the second body 320. When the second body 320 is slid away from a position in which the first body 310 is overlapping the second body 320, the upper portion of the first body 310 is exposed, thereby exposing the key input unit 120.

The key input unit 120 includes a plurality of keys, and the keys include different characters or numbers, respectively. In addition, the key input unit 120 may include a lighting unit (not illustrated) on a lower portion. In response to pressing a key, the lighting unit of the key input unit 120 allows either the pressed key or the other non-pressed keys to emit light under the control of the control unit 130. As a result, the user is able to visibly recognize the pressing of a particular key only with seeing the key input unit 120. In addition, the control unit 130 may control a period of time for emitting light from the key input unit 120 to be shorter than a period of time for which a key has been pressed, so that the key input unit 120 continuously emits light from a particular pressed key even after the user removes the finger from the key and thereby the user can visibly recognize the pressing of the particular key.

The display unit 110 may be a liquid crystal display (LCD) to display information on the mobile device 300 and characters, numbers and the like that are input through the key input unit 120. Thus, under the control of the control unit 130, the display unit 110 allows the user to visibly identify the characters or numbers input through the key input unit 120.

FIG. 5 is a diagram illustrating a perspective view of another example of a mobile device equipped with a key input apparatus according to an exemplary embodiment of the present invention.

Referring to FIG. 5, mobile device 400 may include a body 410, a display unit 110 formed on the entire surface of the body 410, and a touch panel 411 formed on the display unit 110. The display unit 110 may include a first region 420 which displays an image of a key input unit 120 such as a keypad or a keyboard and a second region 430 which provides a key confirmation window. In addition, the forms of the first region 420 and the second region 430 may not be limited to the forms shown in FIG. 4, and only one of the first region 420 and the second region 430 may be displayed on the display unit 110. The touch panel 411 detects a touch on a point at which a particular key is positioned in the key input unit 120 displayed on the display unit 110, thereby recognizing the input on the particular key. In response to the particular key being pressed through the touch panel 411, the display unit 110 emits light from a position corresponding to the particular key, so that the user can visibly recognize the pressing of the particular key. In addition, the display unit 110 may additionally deliver sound or vibration, allowing the user to recognize the pressing of the key. In this case, light emitted from the display unit 110 may be set to have different colors according to the order of pressing keys, and thus the user can be taught the input order of characters or numbers by the colors of light.

As apparent in the above examples, a key input apparatus capable of displaying key inputs using light and a method of emitting the light may allow a user to visibly recognize the key input with the light without seeing a display of a mobile device and thus easily determine wrong key input. Therefore, a wrong input key may be quickly recognized and then cancelled, so that the key input time can be reduced.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A key input apparatus capable of displaying a key input using light, comprising:
a display unit configured to display an input character and/or an input number;
a key input unit configured to include a plurality of keys, output a key signal in response to pressing a particular key corresponding to the character or number among a plurality of the keys, and distinguish the particular key from the other keys using light; and
a control unit configured to output information on the character or number to the display unit in response to the key signal, display the character or number corresponding to the particular key in the display unit and control a period of time for which the particular key is distinguishable using light to be longer than a period of time for which the particular key has been pressed.

2. The key input apparatus of claim 1, wherein the control unit is further configured to distinguish the particular key from the other keys by a difference in brightness of emitted light therefrom, to set the difference in brightness to change over time, and, if there are a plurality of particular keys, to allow a user to recognize an input order of the particular keys based on brightness of emitted light from the particular keys.

3. The key input apparatus of claim 1, wherein the control unit is further configured to control a particular key to emit light, among a plurality of the keys, so as to be distinguished from the other keys.

4. The key input apparatus of claim 1, wherein the control unit is further configured to control all keys other than a particular key among a plurality of the keys to emit light so as for the particular key to be distinguished from the other keys.

5. The key input apparatus of claim 3, wherein the control unit is further configured to control a plurality of pressed keys to sequentially emit light of different colors according to an order of pressing the keys.

6. The key input apparatus of claim 5, wherein the control unit is further configured to set the colors of light corresponding to an order of pressing a plurality of the keys.

7. The key input apparatus of claim 3, wherein the control unit is further configured to control the particular key to emit light in a particular shape.

8. The key input apparatus of claim 7, wherein the control unit is further configured to set an order of shapes of light in accordance with an order of pressing a plurality of the keys.

9. A method of emitting light from a key input apparatus, comprising:
recognizing a particular key being pressed in a key input unit including a plurality of keys; and
emitting light from the pressed particular key for a predetermined period of time which is longer than a period of time for which the particular key has been pressed.

10. The method of claim 9, wherein in the emitting of the light, the key input unit distinguishes the particular key from the other keys by a difference in brightness of emitted light therefrom, and sets the difference in brightness to change over time, and, if there are a plurality of particular keys in the key input unit, the key input unit displays key inputs using light such that a user can recognize an input order of the particular keys based on brightness of emitted light from the particular keys.

11. The method of claim 9, wherein the emitting of the light comprises emitting light of different colors according to an order of pressing the particular keys.

12. The method of claim 9, wherein the emitting of the light comprises emitting light in different shapes according to an order of pressing the particular keys.
